(19) United States
(12) Patent Application Publication
(10) Pub. No.: US 2012/0291292 A1
(43) Pub. Date: Nov. 22, 2012

(54) Folding knife with safety switch

(75) Inventor: Yang-Fu Cheng, Taipei (TW)

(73) Assignee: KANTAS PRODUCTS CO., LTD., Taipei (TW)

(21) Appl. No.: 13/067,825

(22) Filed: Jun. 29, 2011

(30) Foreign Application Priority Data
May 16, 2011 (TW) 100208714

(51) Int. Cl. B26B 1/04

(52) U.S. Cl. 30/161

(57) ABSTRACT

The present invention relates to a folding knife having a blade pivotally connected to a handle and a positioning device including a resilient plate and a positioning element, wherein the positioning element has a middle section pivotally connected in the handle, and the resilient plate has a first end fixed in the handle and a second end movably pressing against a first end of the positioning element and thereby causing a second end of the positioning element to press against the blade. A safety switch has a first end jutting out of the handle and a second end movably located in the handle and corresponding to the resilient plate. When the safety switch is moved toward the blade, the second end of the safety switch is inserted between the positioning element and the resilient plate to prevent the positioning element from swinging about an axis defined by its middle section.

### FIELD OF THE INVENTION

The present invention relates to a folding knife, more particularly to a folding knife with a safety switch.

### BACKGROUND OF THE INVENTION

Recently, with the advancement of craft techniques and the improvement of living standards, people who intend to buy a new product consider not only the price and durability of the product, but also whether the product is convenient and safe to use. Such a change in market trends has driven manufacturers and designers in all fields to develop new and better products on a regular basis so as to meet consumers' needs. Take the folding knives commonly used in outdoor recreational activities for example. While folding knives are commercially available in a variety of types, with the most common selling points being their compact and elaborate designs and high portability, there is still room for improvement in terms of user safety. As not all users of such knives are experienced users, folding knives with safety defects in design are very likely to cause danger during use.

Please refer to FIG. 1 for the internal structure of a conventional folding knife 1. The folding knife 1 includes a blade 11 and a handle 12. The blade 11 is pivotally connected to the handle 12 at a position adjacent to a first end of the handle 12, so the blade 11 can be rotated out of the handle 12 from one side thereof or be received in the handle 12. Inside the handle 12 are a resilient plate 121 and a positioning element 122. The resilient plate 121 has a first end fixed to the handle 12 at a position adjacent to a second end of the handle 12 and a second end movably positioned in the handle 12. The positioning element 122 has a middle section pivotally connected in the handle 12, a first end extending to a position adjacent to a first end (i.e., the pivotally connected end) of the blade 11, and a second end in contact with the second end of the resilient plate 121, so as for the resilient plate 121 to press against the positioning element 122 and cause the first end of the positioning element 122 to, in turn, press against the first end of the blade 11, thereby fixing the blade 11 in position outside the handle 12. In addition, the positioning element 122 has a pressing portion 123 corresponding in position to the resilient plate 121. When it is desired to fold the blade 11 into the handle 12, the user can press the pressing portion 123 so that the first end of the positioning element 122 is disengaged from the first end of the blade 11, thus allowing the user to fold the blade 11 into the handle 12 by rotating the blade 11 toward the handle 12. Although the blade 11 can be secured outside the handle 12 by the resilient force of the resilient plate 121 in order for use, the folding knife 1 still has the following drawbacks:

(1) Inadequate safety: The pressing portion 123 must jut out of the handle 12 so that, when it is desired to fold the blade 11 into the handle 12, the pressing portion 123 can be easily pressed to release the pressing force applied by the positioning element 122 to the blade 11. However, as the user must grip the handle 12 firmly when using the folding knife 1, the pressing portion 123 is very likely to be pressed by accident while the folding knife 1 is used. Should it happen, the blade 11 may suddenly fold into the handle 12 and cut the user's hand as a result, which is extremely unsafe.

(2) Instability of the blade 11: The folding knife 1 uses the resilient force of the resilient plate 121 to drive the positioning element 122, which in turn delivers the resilient force to the first end of the blade 11 and thereby fixes the blade 11 in position outside the handle 12 for use. However, no matter the blade 11 is positioned outside the handle 12 or received therein, the resilient plate 121 keeps pressing against the positioning element 122 and is never relaxed. Moreover, while the folding knife 1 is used, the reaction force acting on the blade 11 is also transmitted to the resilient plate 121 via the positioning element 122. Therefore, when the folding knife 1 has been used for a long time, the resilience of the resilient plate 121 may have weakened to such extent that the blade 11 cannot be firmly positioned outside the handle 12. Instability of the blade 11 causes tremendous inconvenience to the user and compromises the performance of the folding knife 1.

Hence, the issue to be addressed by the present invention is to design a folding knife which not only provides enhanced safety but also has a second positioning mechanism for keeping the blade of the folding knife securely positioned even if the resilient plate is elastically fatigue or is damaged by external impact, thus extending the service life of the folding knife.

### BRIEF SUMMARY OF THE INVENTION

In view of the various drawbacks of the conventional folding knives, the inventor of the present invention put years of practical experience into research and experiment and finally succeeded in developing a folding knife with a safety switch as disclosed herein. The disclosed folding knife is improved in safety and has a second positioning mechanism for extending the service life of the folding knife.

It is an object of the present invention to provide a folding knife with a safety switch, wherein the folding knife includes a blade, a handle, and a positioning device in addition to the safety switch. The handle includes a first plate and a second plate. A pivot is provided between the first plate and the second plate at a position adjacent to one end of the first plate and one end of the second plate. The blade is pivotally connected to the pivot such that a portion of the blade that is adjacent to a first end of the blade is positioned between the plates. The blade can be rotated out of the handle from a first side thereof or be rotated into the handle and received therein. The positioning device is provided between the first plate and the second plate and includes a resilient plate and a positioning element. The resilient plate has a first end fixed in the handle and a second end movably positioned in the handle. The positioning element has a middle section pivotally connected in the handle (e.g., pivotally connected to the first plate and/or the second plate). The positioning element also has a first end extending to a position between the resilient plate and a second side of the handle, so as for the resilient plate to press against the positioning element and thereby cause a second end of the positioning element to press against a portion of the blade that is adjacent to the pivot. The second end of the positioning element corresponds in configuration to the portion of the blade that is adjacent to the pivot so that, when the blade is fully rotated out of the handle, the second end of the positioning element is engaged with the portion of the blade that is adjacent to the pivot, thereby positioning the blade securely outside the handle. The positioning element has a pressing portion corresponding in position to the resilient plate and jutting out of the handle. When it is desired to fold the blade into the handle, the user can press the pressing portion and thereby cause the positioning element to swing about an axis defined by its middle section. As a result, the second end of the positioning element separates from the portion of the blade that is adjacent to the pivot, and the blade is disengaged from the positioning element and ready to be received in the handle. The safety switch is movably embedded in the handle. The safety switch has a first end jutting out of an opening of the handle and a second end located in the handle and corresponding in position to the resilient plate. The safety switch can be moved along the longitudinal direction of the handle so that the second end of the safety switch is inserted between the positioning element and the resilient plate to prevent the positioning element from swinging about the axis defined by its middle section. Alternatively, the second end of the safety switch can be withdrawn from between the positioning element and the resilient plate, thereby allowing the positioning element to swing about the axis defined by its middle section and disengage from the blade. Thus, the safety switch prevents accidental folding of the blade which may otherwise occur if the user holds the handle so tight that the pressing portion is inadvertently pressed.

It is another object of the present invention to provide the foregoing folding knife, wherein the folding knife further includes a resilient element provided in the handle. The resilient element has a first end fixed between the first plate and the second plate and a second end pushing the safety switch toward the end of the handle that is adjacent to the pivot, so as for the second end of the safety switch to be inserted in between the positioning element and the resilient plate and press against the first end of the positioning element. The resilient element is designed to prevent the safety switch from shifting in place or getting loose when the folding knife is shaken or swung during use. Furthermore, the safety switch, when pressing against the positioning element, can share a portion of the reaction force transmitted from the blade to the resilient plate while the folding knife is used; thus, the safety switch also contributes to extending the service life of the resilient plate.

Yet another object of the present invention is to provide the foregoing folding knife, wherein the opening of the handle can be formed between the first plate and the second plate or be provided on one of the first plate and the second plate. This is intended to suit different users' habits of pushing the safety switch and enhance the operational smoothness of the folding knife.

### BRIEF DESCRIPTION OF THE SEVERAL VIEWS OF THE DRAWINGS

The structure as well as a preferred mode of use, further objects, and advantages of the present invention will be best understood by referring to the following detailed description of the preferred embodiments in conjunction with the accompanying drawings, in which:

FIG. 1 shows a conventional folding knife, with part of the handle removed;

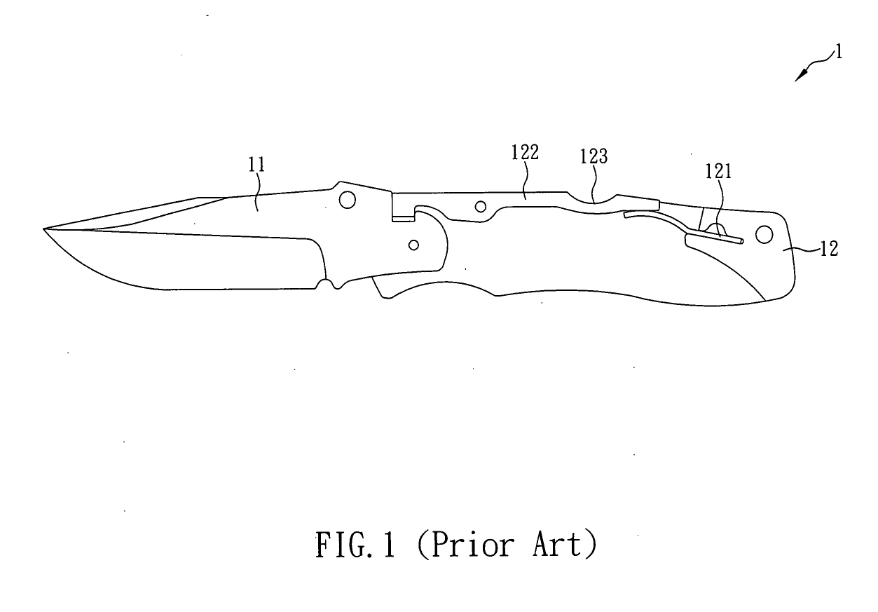

FIG. 2 is an exploded perspective view of a folding knife according to the first preferred embodiment of the present invention;

FIG. 3 shows the folding knife of FIG. 2, with part of the handle removed;

FIG. 4 shows the folding knife of FIG. 2 in a different state, with part of the handle removed;

FIG. 5 shows a folding knife according to the second preferred embodiment of the present invention, with part of the handle removed; and

FIG. 6 is an exploded perspective view of a folding knife according to the third preferred embodiment of the present invention.

### DETAILED DESCRIPTION OF THE INVENTION

The inventor of the present invention has long been engaged in the research, development, and manufacture of folding knives and like products. In the process, the inventor has found that most of the existing folding knives have safety problems and may cut the users by accident. While attempts have been made to overcome these problems by improving the overall structure of folding knives, an ideal solution has yet to be found. The inventor came up with the idea of equipping a folding knife with a safety switch so that the folding knife is structurally improved to provide smooth operation as well as convenient use.

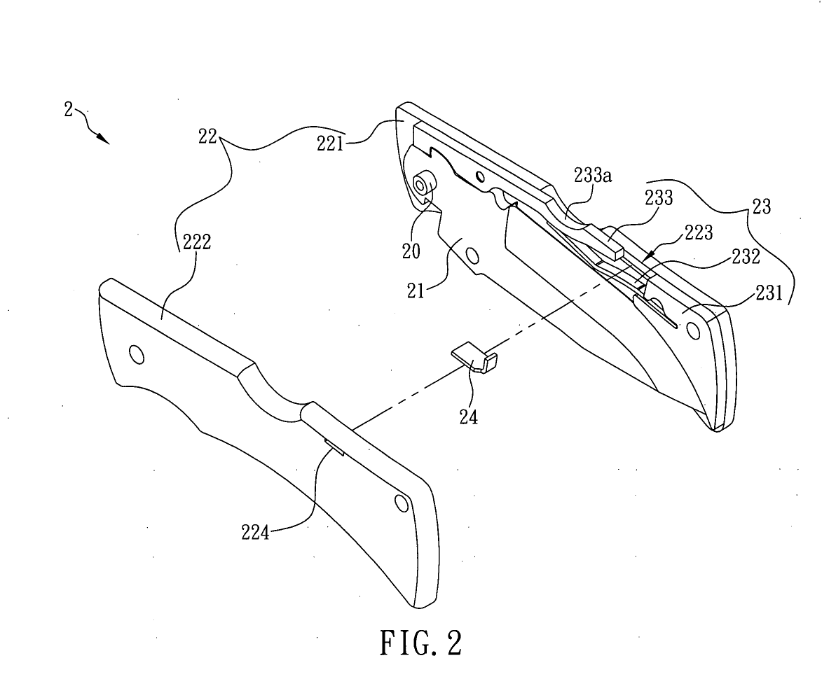

Referring to FIG. 2, a folding knife 2 according to the first preferred embodiment of the present invention includes a blade 21, a handle 22, a positioning device 23, and a safety switch 24. The handle 22 includes a first plate 221 and a second plate 222. A pivot 20 is provided between the first plate 221 and the second plate 222 and is adjacent to a first end of the first plate 221 and a first end of the second plate 222. The blade 21 is pivotally connected to the pivot 20 in such a way that a portion of the blade 21 that is adjacent to a first end of the blade 21 is positioned between the first plate 221 and the second plate 222. Meanwhile, a second end of the blade 21 can be rotated about the pivot 20 and move out of the handle 22 from one side of the handle 22, or the second end of the blade 21 can be rotated into the handle 22 and be received therein. An opening 223 is formed between the first plate 221 and the second plate 222 and corresponds in position to a second side of the handle 22. The positioning device 23 is located between the first plate 221 and the second plate 222 and includes a fixed portion 231, a resilient plate 232, and a positioning element 233. The fixed portion 231 is provided between a second end of the first plate 221 and a second end of the second plate 222. The resilient plate 232 has a first end corresponding in configuration to the fixed portion 231 and engaged therewith. The resilient plate 232 also has a second end movably positioned between the first plate 221 and the second plate 222. The positioning element 233 has a middle section pivotally connected to the first plate 221 and the second plate 222. In addition, the positioning element 233 has a first end extending to a position between the second side of the handle 22 and the resilient plate 232, so as for the second end of the resilient plate 232 to press against a portion of the positioning element 233 that is adjacent to the first end of the positioning element 233, thereby causing a second end of the positioning element 233 to press against a portion of the blade 21 that is adjacent to the pivot 20.

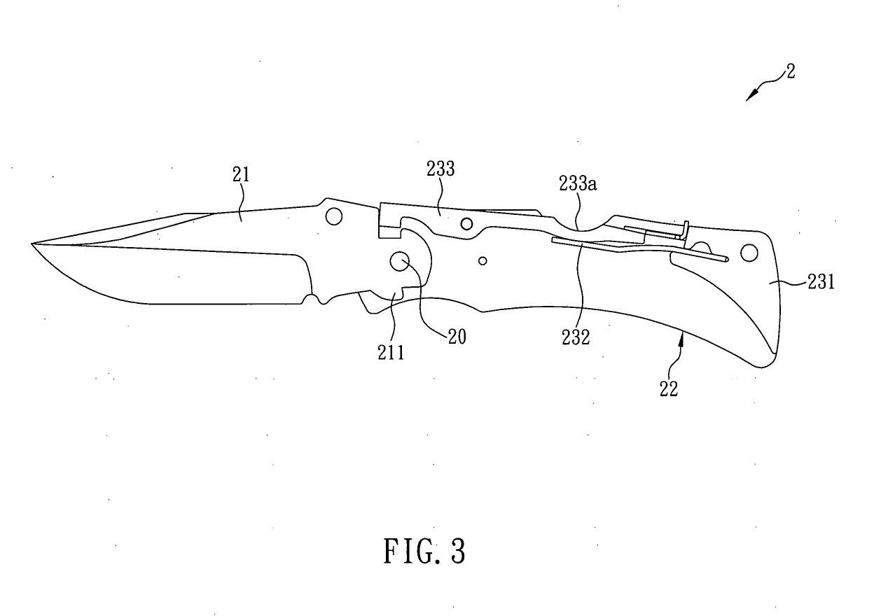

As shown in FIG. 3, the second end of the positioning element 233 corresponds in configuration to the portion of the blade 21 that is adjacent to the pivot 20. Therefore, once the blade 21 is fully rotated out of the handle 22, the second end of the resilient plate 232 presses against the portion of the positioning element 233 that is adjacent to the first end of the positioning element 233, causing the positioning element 233 to swing about an axis defined by its middle section until the second end of the positioning element 233 is tightly engaged with the portion of the blade 21 that is adjacent to the pivot 20. Meanwhile, a portion of the positioning element 233 that corresponds in position to the resilient plate 232 juts out of the second side of the handle 22 and serves as a pressing portion 233a. When it is desired to fold the blade 21 into the handle 22, the user only has to press the pressing portion 233a against the pressing force exerted by the resilient plate 232 on the positioning element 233, and the first end of the positioning element 233 will move further into the handle 22. More specifically, the positioning element 233 will swing in the handle 22 about the axis defined by the middle section of the positioning element 233, causing the second end of the positioning element 233 to separate from the portion of the blade 21 that is adjacent to the pivot 20. In consequence, the blade 21 is disengaged from the positioning element 233, and the user can now rotate the blade 21 into the handle 22. Referring to FIG. 2, when the blade 21 is received in the handle 22, the pressing force of the resilient plate 232 is transmitted via the positioning element 233 to the portion of the blade 21 that is adjacent to the pivot 20, thereby preventing the blade 21 from spinning out of the handle 22 due to gravity. To rotate the blade 21 out of the handle 22, the blade 21 must be pushed out of the handle 22 first, by applying to the blade 21 a force greater than the pressing force of the resilient plate 232.

With reference to FIGS. 2 and 3, the safety switch 24 is movably embedded in the handle 22 and corresponds in configuration to the opening 223 of the handle 22. The safety switch 24 has a first end jutting out of the opening 223 of the handle 22 and is movable along the longitudinal direction of the handle 22. The safety switch 24 also has a second end which is located in the handle 22 and corresponds in position to the resilient plate 232. The safety switch 24 can be displaced along the longitudinal direction of the handle 22 in such a way that the second end of the safety switch 24 is inserted in between the positioning element 233 and the resilient plate 232, so as to prevent the positioning element 233 from swinging about the axis defined by its middle section and thereby ensure that the blade 21 is securely positioned outside the handle 22. Alternatively, the safety switch 24 can be displaced in such a way that the second end of the safety switch 24 is withdrawn from between the positioning element 233 and the resilient plate 232. Thus, the positioning element 233 is allowed to swing about the axis defined by its middle section and disengage from the blade 21, so as for the user to fold the blade 21 into the handle 22. Therefore, in order to prevent the pressing portion 233a from being inadvertently pressed by an excessively large gripping force applied by the user to the handle 22 while using the folding knife 2, the user can push the first end of the safety switch 24 so that the second end of the safety switch 24 is inserted in between the positioning element 233 and the resilient plate 232 and presses against the first end of the positioning element 233. By doing so, the user's hand is protected from cutting injuries which may otherwise occur if the blade 21 is suddenly freed. Moreover, as the second end of the safety switch 24 can be pressed against the first end of the positioning element 233, should the resilience of the resilient plate 232 be impaired (e.g., because of elastic fatigue or external impact), or in case the blade 21 cannot be sufficiently secured, the user can use the safety switch 24 to fix the first end of the positioning element 233 at the second side of the handle 22 to ensure that the blade 21 is firmly positioned outside the handle 22. Thus, the safety switch 24 serves as a second positioning mechanism of the folding knife 2. At the same time, the safety switch 24 can reduce the reaction force transmitted from the blade 21 to the resilient plate 232 while the folding knife 2 is used. Hence, the safety switch 24 also contributes to extending the service life of the folding knife 2.

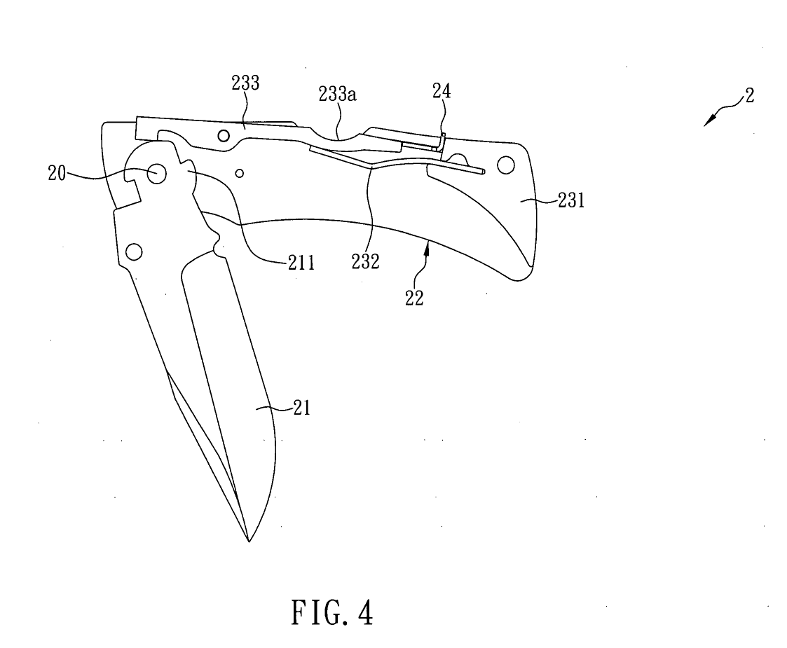

As shown in FIG. 2, the handle 22 in the first preferred embodiment of the present invention further has at least one positioning groove 224. The positioning groove 224 corresponds in configuration to the safety switch 24 such that a portion of the safety switch 24 that is adjacent to the second end of the safety switch 24 is movably engaged in the positioning groove 224. While the safety switch 24 is moved along the longitudinal direction of the handle 22, the positioning groove 224 helps position the safety switch 24 precisely in between the positioning element 233 and the resilient plate 232. Moreover, when the folding knife 2 is shaken or swung, the positioning groove 224 prevents the safety switch 24 from shifting in position. In addition, referring to FIG. 4, a projection 211 is protrudingly provided on the portion of the blade 21 that is adjacent to the pivot 20. The projection 211 corresponds in configuration to a portion of the positioning element 233 that is adjacent to the second end of the positioning element 233. Once the blade 21 is received in the handle 22, the projection 211 is engaged with the portion of the positioning element 233 that is adjacent to the second end of the positioning element 233, thus allowing the user to know for sure that the blade 21 is fully received in the handle 22. This also ensures that the user can carry the folding knife 2 around safely. Furthermore, once the blade 21 is received in the handle 22, the user can also push the safety switch 24 so that the second end of the safety switch 24 is inserted between the positioning element 233 and the resilient plate 232 and thereby fixes the first end of the positioning element 233 in position, as a means to prevent the blade 21 from spinning out of the handle 22.

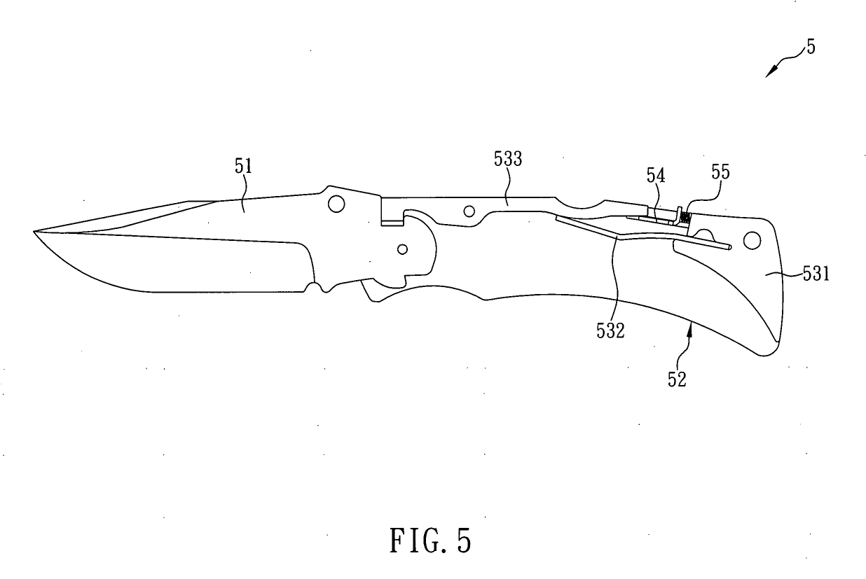

In the second preferred embodiment of the present invention as shown in FIG. 5, the folding knife 5 further includes a resilient element 55 provided between the fixed portion 531 and the safety switch 54. The resilient element 55 has a first end fixed to the fixed portion 531 and a second end pushing the safety switch 54 toward the end of the handle 52 where the pivot is located. As such, the resilient element 55 can drive the safety switch 54 further in between the positioning element 533 and the resilient plate 532 and cause the safety switch 54 to press against the first end of the positioning element 533, thereby preventing the safety switch 54 from shifting when the folding knife 5 is shaken or swung. Hence, the resilient element 55 helps ensure that the position of the blade 51 is secured in relation to the handle 52.

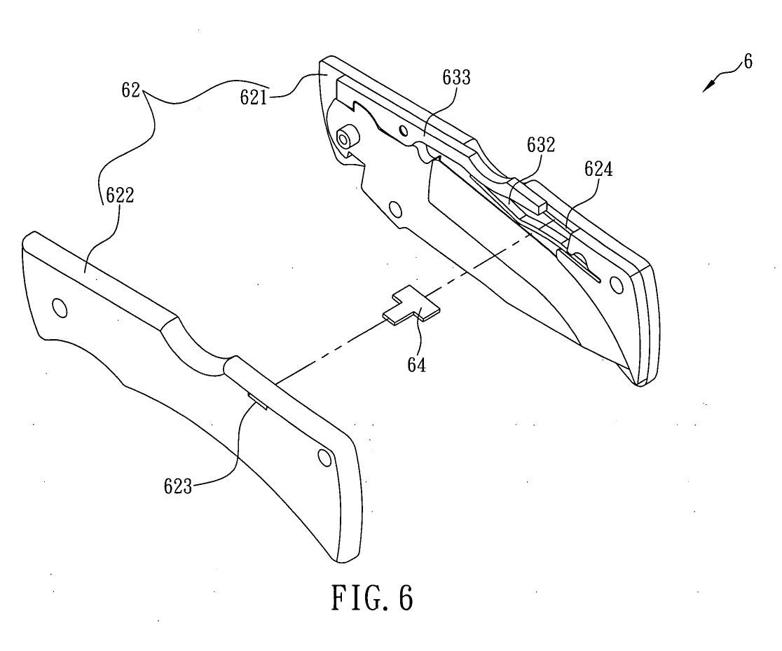

Referring again to FIG. 2, the opening 223 in the first preferred embodiment of the present invention is provided on the second side of the handle 22 and is formed between the first plate 221 and the second plate 222. However, the location of the opening 223 is not limited to the above. In other preferred embodiments of the present invention, the opening 223 can be provided elsewhere on the handle 22 to suit different users' habits of use of folding knives. For example, in the third preferred embodiment of the present invention as shown in FIG. 6, the opening 623 is formed on the second plate 622 and is adjacent to the second side of the handle 62, such that the first end of the safety switch 64 is engaged in the positioning groove 624 formed on the first plate 621 while the second end of the safety switch 64 juts out of the opening 623. Therefore, in this embodiment, it is the second end of the safety switch 64 that the user pushes in order to move the safety switch 64 along the longitudinal direction of the handle 62 and insert the safety switch 64 in between the positioning element 633 and the resilient plate 632. By placing the opening 623 (and the end of the safety switch 64 that juts out of the opening 623 and is intended to be pushed by the user) at the most convenient position on the handle 62, the folding and unfolding of the folding knife 6 can be made easier and smoother.

While the invention herein disclosed has been described by means of specific embodiments, numerous modifications and variations could be made thereto by those skilled in the art without departing from the scope of the invention set forth in the claims.

What is claimed is:

1. A folding knife with a safety switch, comprising:
a blade;
a handle comprising a first plate and a second plate, wherein a pivot is provided between the first plate and the second plate at a position adjacent to an end of the first plate and an end of the second plate, and the blade is pivotally connected to the pivot such that a portion of the blade that is adjacent to a first end of the blade is positioned between the first plate and the second plate while a second end of the blade can be rotated out of the handle from a first side thereof about the pivot or be rotated into the handle and received therein, the handle further comprising an opening;
a positioning device provided between the first plate and the second plate and comprising a resilient plate and a positioning element, the resilient plate having a first end fixed in the handle and a second end movably positioned between the first plate and the second plate, the positioning element having a middle section pivotally connected in the handle and a first end extending to a position between the resilient plate and a second side of the handle, so as for the second end of the resilient plate to press against a portion of the positioning element that is adjacent to the first end of the positioning element, thereby causing a second end of the positioning element to press against a portion of the blade that is adjacent to the pivot, wherein when the blade is fully rotated out of the handle, the second end of the positioning element is engaged with the portion of the blade that is adjacent to the pivot; and
the safety switch movably embedded in the handle and corresponding in configuration to the opening, the safety switch having a first end jutting out of the opening so that a user can push the first end of the safety switch and thereby move the safety switch along a longitudinal direction of the handle, the safety switch further having a second end located in the handle and corresponding in position to the resilient plate, wherein the second end of the safety switch can be inserted in between the positioning element and the resilient plate, thereby preventing the positioning element from swinging about an axis defined by the middle section of the positioning element, or be withdrawn from between the positioning element and the resilient plate, thereby allowing the positioning element to swing about the axis defined by the middle section of the positioning element and disengage from the blade.

2. The folding knife of claim 1, wherein the opening is provided on the second side of the handle and is formed between the first plate and the second plate.

3. The folding knife of claim 1, wherein the opening is provided on the first plate or the second plate and is adjacent to the second side of the handle.

4. The folding knife of claim 2, wherein the handle is further provided with a positioning groove, the positioning groove corresponding in configuration to the safety switch such that a portion of the safety switch that is adjacent to the second end of the safety switch is movably engaged with the positioning groove.

5. The folding knife of claim 3, wherein the handle is further provided with a positioning groove, the positioning groove corresponding in configuration to the safety switch such that a portion of the safety switch that is adjacent to the second end of the safety switch is movably engaged with the positioning groove.

6. The folding knife of claim 4, further comprising a resilient element having a first end fixed in the handle and a second end pushing the safety switch toward an end of the handle that is adjacent to the pivot, so as for the safety switch to be inserted in between the positioning element and the resilient plate.

7. The folding knife of claim 5, further comprising a resilient element having a first end fixed in the handle and a second end pushing the safety switch toward an end of the handle that is adjacent to the pivot, so as for the safety switch to be inserted in between the positioning element and the resilient plate.

8. The folding knife of claim 6, wherein the portion of the blade that is adjacent to the pivot is protrudingly provided with a projection, the projection corresponding in configuration to a portion of the positioning element that is adjacent to the second end of the positioning element such that, when the blade is received in the handle, the projection is engaged with the portion of the positioning element that is adjacent to the second end of the positioning element.

9. The folding knife of claim 7, wherein the portion of the blade that is adjacent to the pivot is protrudingly provided with a projection, the projection corresponding in configuration to a portion of the positioning element that is adjacent to the second end of the positioning element such that, when the blade is received in the handle, the projection is engaged with the portion of the positioning element that is adjacent to the second end of the positioning element.
